(19) United States
(12) Patent Application Publication
(10) Pub. No.: US 2015/0242913 A1
(43) Pub. Date: Aug. 27, 2015

(54) ENTERPRISE PRICE QUOTE GENERATION

(71) Applicants: Verizon Deutschland GmbH, Frankfurt am Main (DE); Verizon Patent and Licensing Inc., Basking Ridge, NJ (US)

(72) Inventors: Anil Chintalapudi, Irving, TX (US); Dinesh Agarwal, Irving, TX (US); Arka Ganguly, Dallas, TX (US); Vishwas Parameshwarappa, Irving, TX (US); Thorsten Themann, Gelsenkirchen (DE)

(73) Assignees: Verizon Deutschland GmbH, Frankfurt am Main (DE); Verizon Patent and Licensing Inc., Basking Ridge, NJ (US)

(21) Appl. No.: 14/186,704

(22) Filed: Feb. 21, 2014

(51) Int. Cl. G06Q 30/06

(52) U.S. Cl. CPC G06Q 30/0611

(57) ABSTRACT

A method includes receiving, from a client enterprise, at a provider computing device, a request for price quote for products provided by a provider enterprise and determining a plurality of discrete processing units based on the request for price quote. The method includes assigning each of the plurality of discrete processing units to a single one of a plurality of parallel processing devices. The method includes accessing, by each of the plurality of parallel processing devices, price quote generation data stored in a hierarchical manner in a database associated with the provider, and processing the discrete processing units the plurality of discrete processing units based on the price quote generation data to generate a corresponding plurality of processed units. The method includes merging the processed units to form concatenated processed units and adding global components to the concatenated processed units to form the price quote.

### BACKGROUND

Enterprise organizations may provide products and services to other enterprise organizations (i.e., a customer or client enterprise of a provider enterprise). These “enterprise-to-enterprise” or E2E transactions often involve multiple locations for the customer enterprise and different combinations of products and services for the different locations. For example, a telecommunications service provider may provide different combinations of telecommunications products and services, such as particular customer premises equipment (CPE), network services, voice over Internet protocol (VoIP) services, etc., to different locations associated with an enterprise customer.

Sales personnel for the provider (and other authorized or pertinent parties to transactions) may access and provide sales quotes for products that are to be provided to prospective customers and other information relevant to a sales quote or prospectus. Pricing quotes for the different products and services for multiple locations of the client enterprise often require generation of large scale electronic documentation that covers transaction for the multiple locations in addition to the entire transaction. In some instances, the electronic documentation may be provided in portable document format (PDF) files and/or spreadsheet format files (e.g., Microsoft Excel files).

### BRIEF DESCRIPTION OF THE DRAWINGS

FIG. 1 illustrates an exemplary environment in which systems and methods described herein may be implemented;

FIG. 2 illustrates an exemplary large scale electronic document for an enterprise-to-enterprise transaction that includes multiple sites, products and charges;

FIG. 3 illustrates an exemplary page of the large scale electronic document of FIG. 2;

FIG. 4 is a diagram of exemplary functional components of the quote generation system of FIG. 1;

FIG. 5 is a diagram of logic components of the site splitting module of FIG. 4;

FIG. 6 is a diagram of logic components of one of the parallel site processing modules of FIG. 4;

FIG. 7 is a diagram of logic components of the merger module of FIG. 4;

FIG. 8 illustrates an exemplary configuration of one or more of the components of FIG. 1; and

FIG. 9 is a flowchart of an exemplary process for generating large scale electronic documentation for an enterprise-to-enterprise transaction.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may generate large scale electronic documentation for an enterprise-to-enterprise transaction. The enterprise-to-enterprise transaction may include multiple sub-transactions that include multiple locations of a client enterprise (or other identifiable sub-unit of the enterprise-to-enterprise transaction). In one embodiment, the systems and methods may be implemented as a large document generation utility (e.g., a large PDF generation utility). The systems may receive a request for a price quote for products and services to be provided to multiple sites (or locations) of a client enterprise. The systems may divide (or “chunk”) the request into multiple discrete processing units (e.g., defined sub-transactions) and allow parallel processing of the multiple discrete processing units. The systems may merge the multiple processed units in one or more predetermined sequences and apply global processing to the multiple processed units and/or subgroups of the multiple processed units based on metadata definitions. The global processing may include the application of business units, legal entities, variables, attributes, discounts, promotions, footnotes, headers, appendices, disclaimers, translations, sales points, sub line items, notation, formatting, subtotals, totals, etc., to the multiple processed units and/or subgroups of the multiple processed units.

Consistent with described embodiments, the systems and methods may support entry of multiple different types of structured input data (e.g., text files, database queries, extensible markup language (XML)). The systems and methods may allow usage of the large document generation utility for real-time applications of document production for large sales quotes.

As used herein, the terms “customer enterprise,” “client,” “client enterprise,” “client personnel,” “customer,” “consumer,” and/or “prospective customer” may be used interchangeably. The terms “service provider,” “provider,” “administrator,” “sales persons,” “user,” and/or “provider enterprise” may also be used interchangeably. Also, the terms “customer enterprise,” “client enterprise,” “client personnel,” “customer,” “consumer,” “service provider,” “provider,” “administrator,” “sales persons,” “user,” and/or “provider enterprise” are intended to be broadly interpreted to include a device or a user of a device that interfaces, is a component of or otherwise accesses or is accessed by systems described herein.

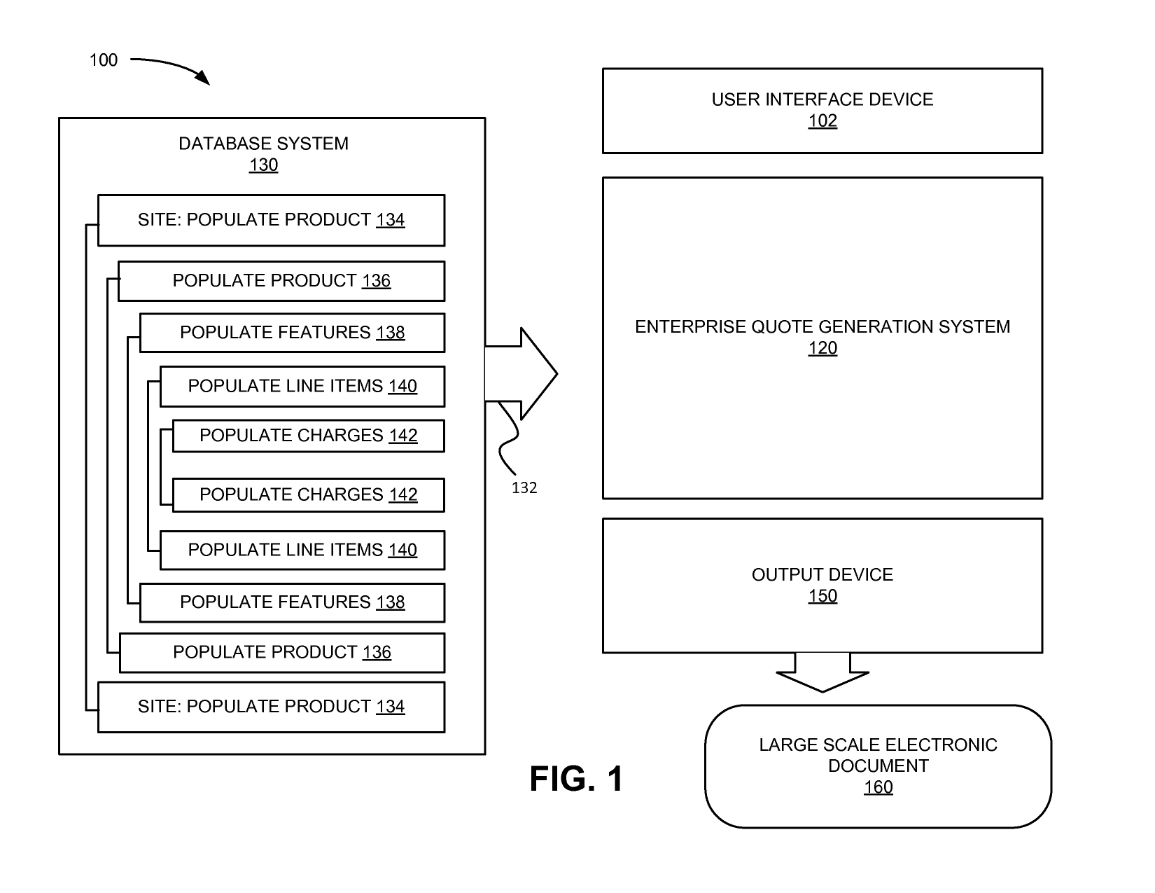

FIG. 1 illustrates an exemplary environment 100 in which systems and/or methods described herein may be implemented. As shown in FIG. 1, environment 100 may include a user interface device 102, an enterprise quote generation system 120, a database system 130, output device 150, and a large scale electronic price quote document 160 (also referred to herein as a price quote, price quote document or a large document). Environment 100 may include devices and systems that may implement a process of handling large volumes of data and conversion of the data to document form in a distributed architecture. Devices and/or networks of FIG. 1 may be connected via wired and/or wireless connections.

User interface device 102 may include any device capable of providing machine readable instructions to enterprise quote generation system 120. User interface device 102 may include an interactive client interface, such as a graphical user interface (GUI). User interface device 102 may provide varying levels of access to these systems by sales personnel for a service provider, customers, client personnel and network administrators associated with the service provider. Examples of user interface device 102 may include a mobile phone, a tablet, a personal computer, or another device that may provide machine readable instructions to enterprise quote generation system 120.

User interface device 102 may provide a price quote entry screen on which personnel may enter information to generate (and, in some instances alter) price quotes from products and services to be provided from the service provider to the client enterprise. For example, products and services may include telecommunications services and products (e.g., customer premises equipment (CPE), network services (Private Internet protocol (IP), Access), voice over Internet protocol (VoIP) services, etc.). User interface device 102 may also access an application library when the user enters the price quote entry screen, and allow the display and receipt of different types of information including products, totals (and subtotals), discounts, approvals (e.g., for particular actions, discounts, variations, etc.), promotions and prices. User interface device 102 may receive a client request that includes client specific price quote information and details (e.g., particular sites of the client enterprise, numbers and types of products and services requested) and input the client request to enterprise quote generation system 120 to generate a price quote document 160 (e.g., a PDF document) for an enterprise-to-enterprise transaction that may be output via output device 150.

Enterprise quote generation system 120 may generate large scale electronic documentation for enterprise-to-enterprise transactions that include multiple sites, locations and/or sub entities of a client enterprise. Large scale electronic documentation may include documentation that is of a predetermined complexity based on one or more of a number of sites, legal entities associated with the service provider (e.g., different companies that provide services under a same service provider, subcontractors, etc.), products, line items, (i.e., charges for subgroups or single items of the products or services), contracting entities (i.e., contracting client sub entities), etc., associated with the transaction. Alternatively, large scale electronic documentation may be defined as a document that exceeds a predetermined size in bits (e.g., data greater than 700 megabytes (MBs)).

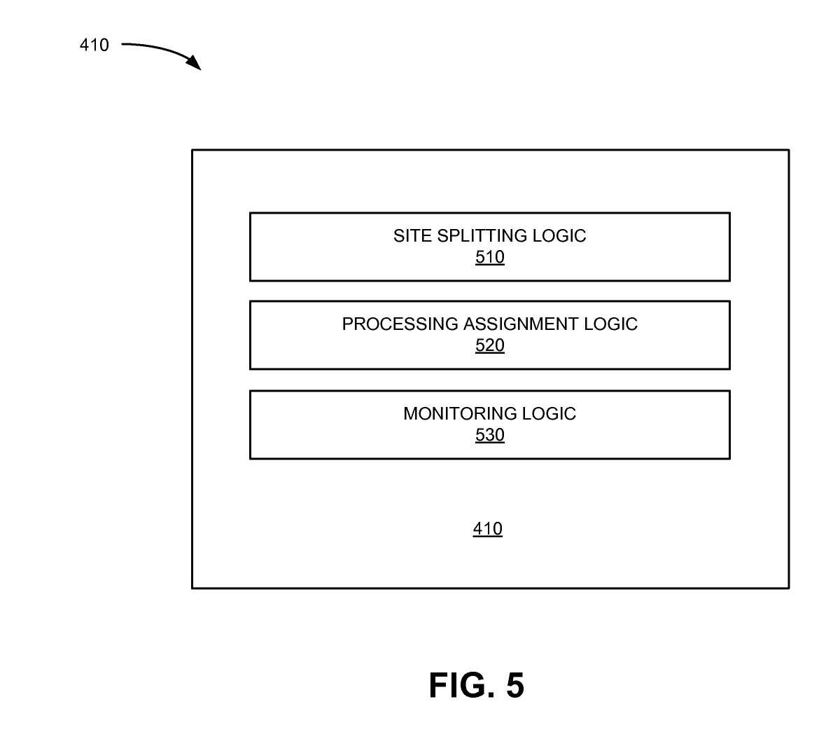

Enterprise quote generation system 120 may receive a request for a price quote for products and services to be provided to multiple sites (or locations) of a client enterprise (e.g., a request input, for example, via user interface device 102). For example, sales personnel for the service provider may receive and input specifications of client locations and products and services to be provided in an enterprise-to-enterprise transaction (e.g., via user interface device 102). Enterprise quote generation system 120 may receive/access price quote generation data 132 from database system 130 that may be used to generate a price quote with the client request. Enterprise quote generation system 120 may divide the client request into multiple discrete processing units based on legal sub entities of the provider, products, sites, rollout dates for particular portions of the enterprise-to-enterprise transaction, etc., and, in some instances, a target size of the discrete processing units (i.e., defined sub-transactions) (e.g., as described with respect to FIG. 5 and site splitting module 410 herein below).

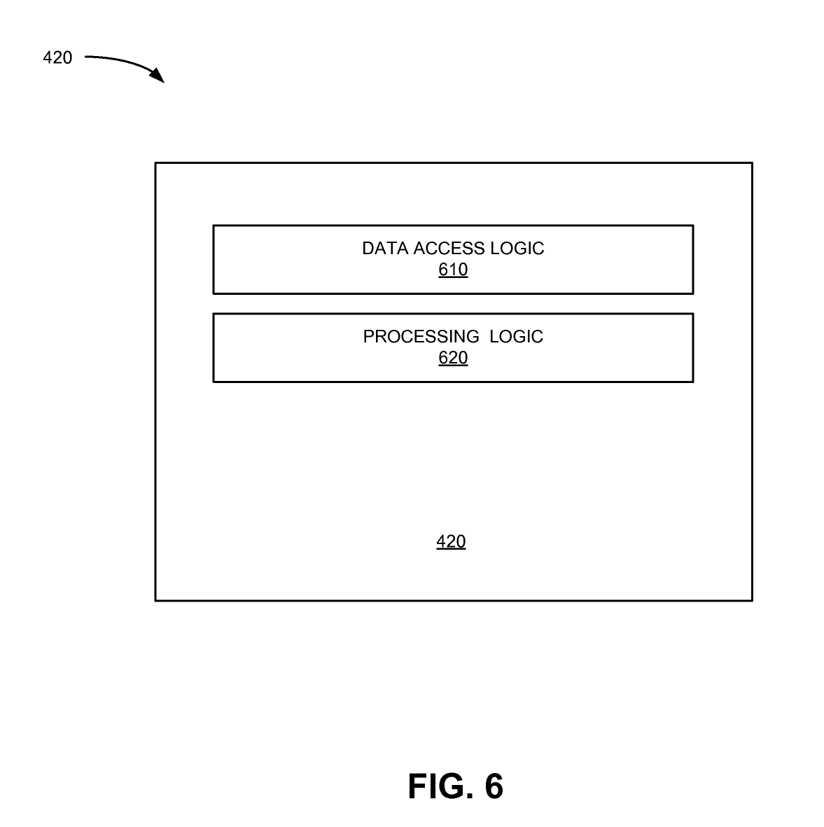

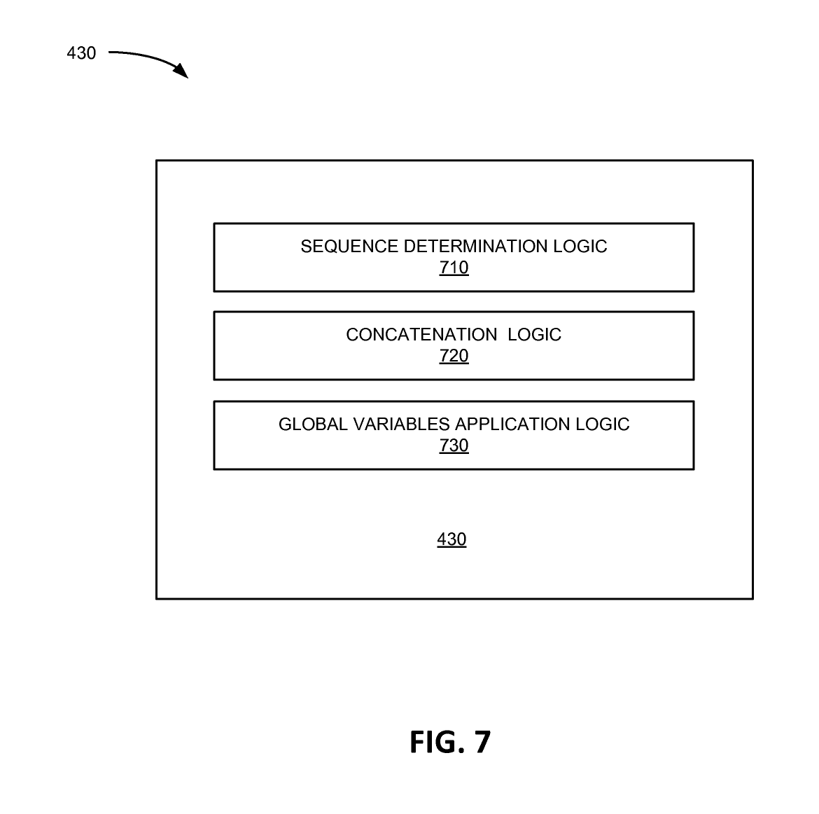

Enterprise quote generation system 120 may allow parallel processing of the multiple discrete processing units (e.g., as described with respect to FIG. 6 and parallel site processing module 420 herein below). Enterprise quote generation system 120 may merge the multiple processed units in one or more predetermined sequences and apply global processing to the multiple processed units and/or subgroups of the multiple processed units based on metadata definitions (e.g., as described with respect to FIG. 7 and merger module 430 herein below). The global processing may include applying common rates, or categories, totaling or subtotaling particular groups of processed units (e.g., products to be provided for a region of a global client enterprise), footnotes, disclaimers, or other global variables that may apply to the processing output of multiple parallel (or separately) processed units.

According to an embodiment, enterprise quote generation system 120 may be implemented as a PDF (and/or Excel) generation utility that may generate large price quotes for enterprise-to-enterprise transactions (e.g., greater than 700 MB in size). Enterprise quote generation system 120 may support real time usage (i.e., applications) for generating large PDF (and other document file formats) documents. Enterprise quote generation system 120 may access client data that describes (or defines) an account hierarchy for complex tasks and large global businesses that operate multiple subsidiaries, different entities, and numerous offices. For example, enterprise quote generation system 120 may access client data for enterprise-to-enterprise transactions in which there are multiple site locations (e.g., 100-5000 site locations), with each location containing multiple serviced products (e.g., hundreds of products). Further, within each product there may be multiple specifications (or features) (e.g., hundreds of specifications), where each specification may have multiple line items, and at every hierarchical level there may be multi-value attributes. Enterprise quote generation system 120 may generate price quotes based on price quote generation data 132 and client data/requests. Enterprise quote generation system 120 may generate an XML representation of enterprise price quote 160 that may be provided as in input to output device 150.

Database system 130 may include price quote generation data 132 structured and stored in a hierarchical manner. The price quote generation data 132 may allow enterprise quote generation system 120 to generate price quotes based on the price quote generation data 132 and specific values provided by the client enterprise for each price quote requested by a particular client enterprise. Price quote generation data 132 may be arranged in a nested hierarchical form in which each lower (or subsequent, dependent or nested) layer of information is dependent or based upon the higher (or preceding) layer of information. For example, price quote generation data 132 may include a first layer that allows the enterprise quote generation system 120 to populate a template document for a particular site 134. Although only a single site data structure is shown with respect to the database system 130, an enterprise customer may have multiple sites on a quote generated based on the single site data structure. Additionally, each lower nested layer may have multiple different instances that may be populated based on the preceding layer (e.g., if site: populate product 134 has been generated, there may be multiple different instances of populate product 136 (which is a lower level to site: populate product 134) that may be generated based on the particular site). In other words, each layer may have multiple different branches based on the next lower layer.

Price quote generation data 132 may allow population of the price quote with a product (or solution) package 136 (e.g., managed network, private Internet protocol (PIP), etc.) for a site of the client enterprise 134 (e.g., enter data in a predetermined format after a particular site has been populated in the document). Price quote generation data 132 may include (allow data population of or entry of data for) products 136 based on a particular package of products and services offered by the service provider. Price quote generation data 132 may allow data population of features (e.g., populate features 138) based on the populated products 136, population of line items based on the products (e.g., populate line items 140), and population of charges based on line items (e.g., populate charges 142). In some instances, the nested values may be optional (e.g., a product may have no listed features 138 or line items 140).

According to an embodiment, database system 130 may include information that allows handling of notations, sub line items and footnotes seamlessly in price quotes based on metadata definitions.

Output device 150 may receive the merged and concatenated product of enterprise quote generation system 120 and process the product to form a price quote document 160. For example, output device 150 may receive the XML representation of enterprise price quote 160 (from enterprise quote generation system 120) and apply object translation to generate a PDF printer object using an open source directory. Output device 150 may receive machine readable instructions that define the layout and the contents of the enterprise price quote 160 (e.g., a price quote PDF document). In one implementation, enterprise quote generation system 120 may output XML data (and, in some instances, the XML data may be translated with—extensible style sheet language transformations (XSLT) file) which may be input into the PDF generation of output device 150.

While FIG. 1 shows a particular number and arrangement of networks and/or devices, in practice, environment 100 may include additional networks/devices, fewer networks/devices, different networks/devices, or differently arranged networks/devices than are shown in FIG. 1. Although examples of price quote documents are described with respect to PDF files, systems and methods described herein may be applied based on any database and file format that supports large data output to a file (e.g., Microsoft Word, Excel, XML object, text file, etc.).

In implementations described herein, a system and method may generate large scale electronic documentation for enterprise-to-enterprise transactions that include multiple locations of a client enterprise. The systems and method may allow process of handling very large volumes of data and PDF conversation in distributed architecture. The systems and methods may handle notations, sub line items and footnotes seamlessly based on metadata definitions. The systems and architectures may provide a utility that can support real time usage for generating large PDF documents in a substantially shorter time than conventional methods (based, for example, on reducing the time of processing due to parallel processing).

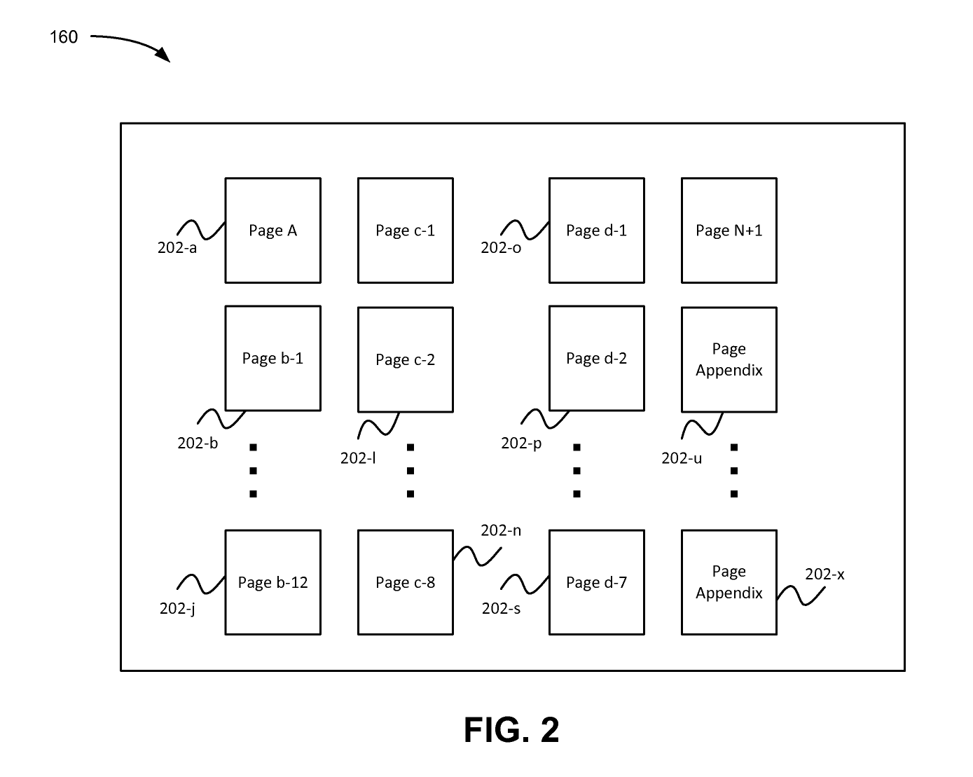

FIG. 2 illustrates an exemplary enterprise price quote 160 (i.e., a large scale electronic document) for an enterprise-to-enterprise transaction that includes multiple sites (or locations), products and charges. As shown in FIG. 2, enterprise quote report 160 may include multiple pages 202-a to 202-x.

In one embodiment, pages 202-a to 202-x of enterprise quote report 160 are arranged in a sequential manner and indexed based on a predetermined system (e.g., alphabetical, geographical, product, provider (sub) entity, etc.). As shown in FIG. 2, pages 202 may be arranged in ranges (e.g., page 202-a to 202-n) that include price quote information for particular sites and corresponding sub-transactions and or subtotals associated with particular products, legal sub entities of the client enterprise, etc. Note that ranges may be of differing length (e.g., different numbers of pages).

Page ranges may correspond to discrete transactions (and associated descriptions, footnotes, annotations, etc.) associated with particular sites, legal sub entities of the client enterprise, etc. For example, page range 202-b to 202-j may correspond to price quotes (including line items, etc.) for a subdivision of the client enterprise (e.g., geographic, business line, etc.) and page range 202-a to 202-n may correspond to price quotes for a different subdivision. In some instances, page ranges may approximately correspond to particular sub-transactions (e.g., pages may include part of one discrete transaction, such as a subtotal page, and part of another transaction). Further, within the page ranges, there may be subgroupings based on discrete sub-transactions of a particular sub-transaction.

Page ranges may correspond to global document descriptions or supplementary material that apply to multiple or all of the transactions in the price quote, such as directories, appendices, disclaimers, table of contents, etc.

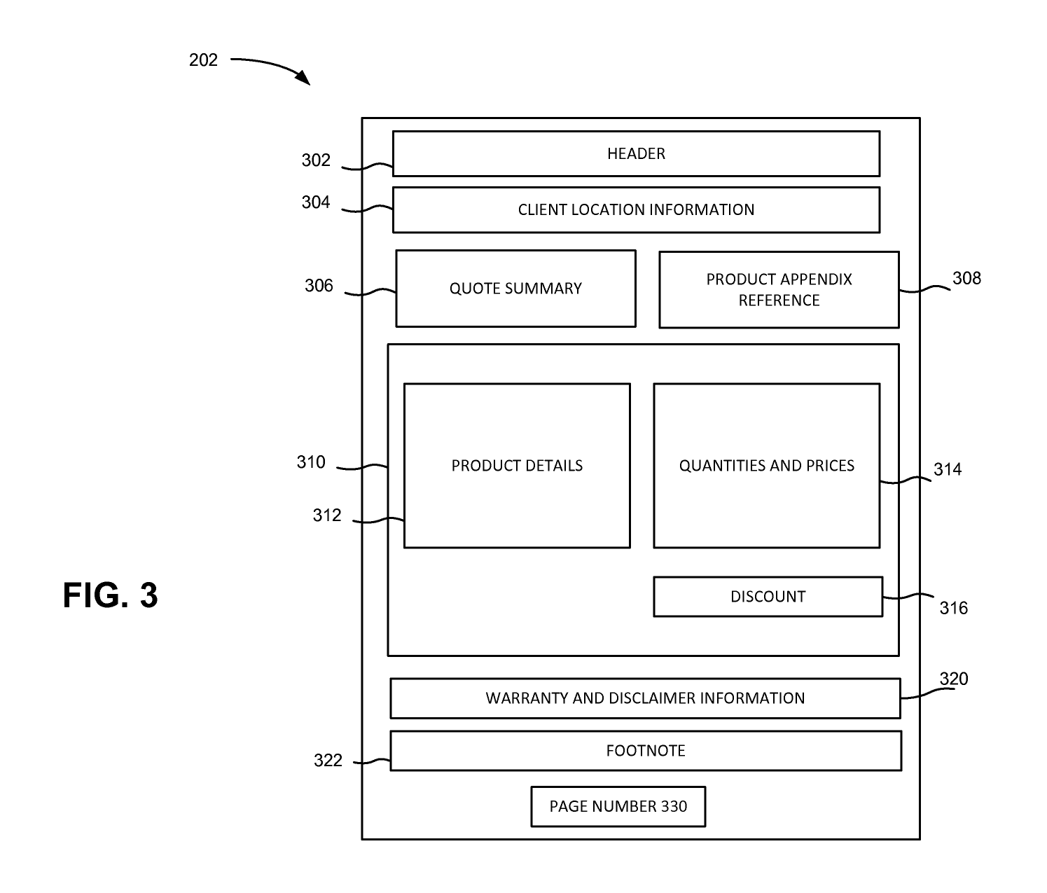

FIG. 3 is a diagram of an exemplary page 202 of an enterprise price quote 160. Page 202 may be a sub-transaction specific page (i.e., page 202 may provide information regarding a sub-transaction associated with a particular client location). As shown in FIG. 3, page 202 may include price quote information, such as header 302, client location information 304, quote summary 306, product appendix reference 308, products 310, product details 312, quantities and prices 314, discounts 316, warranty and disclaimer information 320, footnotes 322 and page numbers 330. Although particular information and page components are shown in FIG. 3 by way of example, it should be understood that page 202 may include any information or page components relevant to providing a price quote including transactions, sub-transactions, and global variables.

Header 302 may include a page header that provides general information regarding the service provider. For example, header 302 may include a logo of the serviced provider or a division of the service provider that provides the products and/or services to the client enterprise.

Client location information 304 may include information identifying a client location. For example, client location information 304 may include a customer entity, a customer office address, customer contracting personnel (e.g., a customer enterprise manager that is a contact to receive the price quote). For example, client location information may include a site ID (e.g., client site 223344), a street address (700 Client Drive), a city (e.g., Irving), state (e.g., TX or Texas), zip code 75038-3811, and country (e.g., United States).

Quote summary 306 may include a summary of the price for the enterprise-to-enterprise transaction. For example, quote summary 306 may include a price charged to the client enterprise for non-recurring charges (i.e., one time) and/or periodic (e.g., monthly recurring) charges in the quote summary 306. Quote summary 306 may include a total of all charges for the client location after any price adjustments based on discounts, rebates, promotions, etc. Quote summary 306 may also include one or more particular currencies and corresponding amounts (e.g., US dollars, UK pounds, etc.) that the charges may be paid.

Product appendix reference 308 may include a reference to an appendix included in the price quote document 160 (for example at the end of the price quote document 160). The appendix may include additional details on products in that page of the price quote. For example, the product appendix reference 308 may provide details on products offered to a particular client location, such as CPE, private IP, VoIP, etc.

Products 310 (listed for the client location) may include products and services provided in the price quote and associated charges for the products and services to be provided to the client (enterprise) location. For example, products 310 may include included in the quote may include single products (or product packages), such as CPE, PIP, VoIP, managed WAN, etc. Corresponding charges for the products provided to the particular client location may also be included in products 310.

Product details 312 may provide details of the products that are to be provided to the client location. Product details 312 may include a breakdown or detailed listing of line items to be provided under a particular product (e.g., for a managed WAN product, line items may include network analysis, routing management, etc.). Product details 312 may indicate the duration of a service to be provided (e.g., 24 months).

Quantities and prices 314 may indicate charges for the products listed under product details 312. The line items may include listed charges associated with the line items.

Discount 316 may indicate discounts associated with the price quote 320. For example, discount 316 may be applied and indicated on a line item basis and/or for the entire sub-transaction associated with the client location.

Warranty and disclaimer information 320 may indicate any warranties or disclaimers associated with particular products or services included in the sub-transaction for the client location. Warranty and disclaimer information 320 may indicate whether the price quote is a final price quote or whether the price quote is subject to change.

Footnotes 322 may indicate further information or may provide links to access further information (e.g., see get help details at “serviceproviderhelp.com”). Footnotes 322 may indicate that charges shown are based upon an estimated quantity, and that the final charge will be calculated based upon actual quantity per the contract at time of invoice and, in some instances, may also include explanation on other legends such as site sequencing numbers, etc.

Page number 330 may be included on each page of price quote 160. Page numbers 330 may be listed sequentially based on an alphanumeric system. In some instances, pages may receive multiple page numbers associated with different indexing within price quote 160 (e.g., general page numbers, such as page 2, and page numbers indicating a particular page range (or subgroup of client locations), such as B1).

Globally relevant material, such as table of contents, appendix, directories and other globally relevant (i.e., relevant to multiple client locations) may be separately included in price quote 160 (e.g., appendix at the end of price quote 160 after listed transactions).

Note that particular components of page 202 may include transaction (or sub-transaction) specific information (e.g., client location, products to be provided to the client location, page numbers for a specific range, such as B1 to B12, etc.) while other components may be globally applied components (e.g., general page numbers, header 302 (in instances in which the header does not include sub-transaction specific information), etc.).

In implementations described herein, price quote 160 may be generated based on information input by a user (e.g., a sales user), for example via user interface device 102. Price quote 160 may include a quote creation date and a calculated quote expiry date that may be displayed in price quote 160 or stored as metadata that describes price quote 160. Price quote 160 may include required approvals and confirmed approvals. The required approvals may be required to generate particular components of price quote 160 (e.g., discounts or exceptions). The confirmed approvals may be entered by credentialed personnel (e.g., a manager with a particular ranking, clearance) to enable generation of price quote 160. The confirmed approvals may be determined based on a digital signature or other identity verification of the approving personnel.

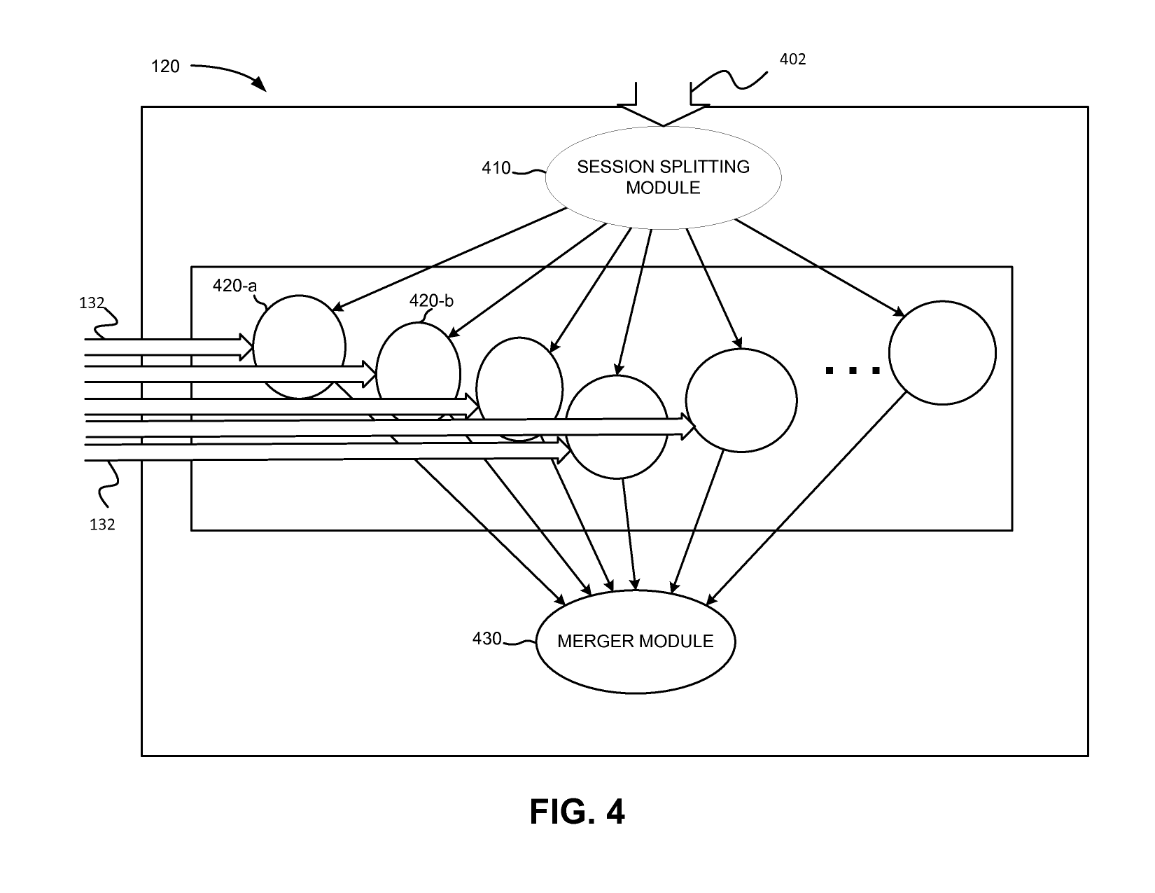

FIG. 4 is a diagram of exemplary functional components of enterprise quote generation system 120 of FIG. 1. As shown in FIG. 4, enterprise quote generation system 120 may include session splitting module 410, a plurality of parallel site processing modules 420a-420n, and merger module 430. Enterprise quote generation system 120 may include other components (not shown in FIG. 4) that aid in generating a price quote document 160 and receiving, transmitting, and/or processing data. Moreover, other configurations of enterprise quote generation system 120 are possible. Enterprise quote generation system 120 may be implemented in a single device or as a group of connected device.

Session splitting module 410 may receive a client price quote request 402. Client price quote request 402 may include information regarding particular client sites and products and/or services to be provided by the service provider to the client enterprise in an enterprise-to-enterprise transaction. Session splitting module 410 may divide the client price quote request 402 into a number of discrete processing units and assign the discrete processing units to parallel site processing modules 420a-420n, such as described below with respect to FIG. 5. Session splitting module 410 may divide the client price quote request based on, for example, particular client sites, provider legal entities that are to fulfill a particular portion of the contract/price quote, types of sub-transactions, etc. Although not shown in FIG. 4, enterprise quote generation system 120 may also include a monitoring process that may monitor the output of parallel site processing modules 420a-420n and. In some instances, may also restart parallel site processing modules 420a-420n in event of failure to produce output The monitoring process may be implemented in conjunction with site splitting processes by session splitting module 410.

Parallel site processing modules 420a-420n may each receive a discrete processing unit and process a sub-transaction for the discrete processing unit, such as described herein below with respect to FIG. 6. In some instances, each of the parallel site processing modules 420a-420n may process an assigned portion of client price quote request 402 on a per site, per provider entity, or per product basis. For example, a particular parallel site processing module 420 (e.g., parallel site processing module 420a) may receive a discrete processing unit that includes a particular client site or set of client sites. Each parallel site processing module 420 may retrieve price quote generation data 132 for the assigned client site. Parallel site processing module 420 may generate sub-transactions for the particular client site (or other discrete processing unit) including requested products, and dependent features, line items, etc. Each of parallel site processing module 420 may provide reporting information to the device based on progress of the processing of the assigned discrete processing unit. Parallel site processing module 420 may output the processed units (e.g., determined sub transactions or other product of processing of the discrete processing unit).

Merger module 430 may receive the processed units from each of the parallel site processing modules 420a-420n. Merger module 430 may receive the processed units when the monitoring process determines that processing for the discrete processing units by parallel site processing modules 420a-420n has been completed. In one example, after all the parallel site processing modules 420a-420n flag (or otherwise indicate) completion of parallel processing threads, merger module 430 may concatenate the chunks of data created by these parallel processes together systematically to create a final middleware XML. Merger module 430 may also receive information indicating a manner in which the processed units are to be merged. Merger module 430 may merge the processed units such as described below with respect to FIG. 7.

FIG. 5 is an exemplary functional block diagram of session splitting module 410 according to an exemplary implementation. As shown in FIG. 5, session splitting module 410 may include site splitting logic 510, processing assignment logic 520, and monitoring logic 530.

Site splitting logic 510 may receive a client request for price quote 402. Site splitting logic 510 may receive the input data of the client request for price quote 402 in a format that may be processed to generate price quotes (e.g., text files, database queries, XML data, etc.). Site splitting logic 510 may retrieve (and process) the entire client request that may include data associated with multiple client sites, products, legal entities, etc., and split the request for price quote 402 into chunks per client site, provider product, provider legal entity, etc., based on the metadata feed to site splitting logic 510. Site splitting logic 510 may determine chunk sizes for discrete processing units based on the entire client request for price quote 402 and/or a number of available parallel processing slots (corresponding to a number of the parallel site processing modules 420a-420n).

According to one embodiment, site splitting logic 510 may divide the client request for price quote 402 based on constraints on parallel process. Each discrete processing unit is atomic and includes separate transactions, sites, etc., from other discrete processing units. Site splitting logic 510 may divide the client request for price quote 402 so that there is no overlap between discrete processing units. Site splitting logic 510 may also divide the client request for price quote 402 into approximately fixed chunks of sites (or fixed approximate processing times) based on the constraints of the sites, legal entities, etc.

According to another embodiment, site splitting logic 510 may divide the client request for price quote 402 based on a navigable feature of price quote 160. For example, in some instances, the service provider may provide the person who accesses the price quote 160 a capability to drill down into particular items to determine finer levels of detail regarding the items. Site splitting logic 510 may configure the discrete processing units to provide levels of quote details on a single discrete processing unit basis or based on groups of discrete processing units. The navigable feature may allow the user to expand, hide or collapse selected items in price quote document 160. For example, price quote 160 may include a site that allows expanding of details by clicking on a predetermined icon.

According to another embodiment, site splitting logic 510 may divide the client request for price quote 402 based on a complexity measure of a discrete processing job associated with particular portions of the request for price quote 402. Site splitting logic 510 may divide the client request for price quote 402 in a manner that generates discrete processing units of substantially similar complexity and/or size of the portions of the client request for price quote 402 (e.g., measured by processing time, number of client sites, number of products, etc.).

Processing assignment logic 520 may assign discrete processing units based on predefined maximum parallel processes (i.e., a predefined number of parallel site processing modules 420a-420n). Processing assignment logic 520 may assign the discrete processing units to the parallel site processing modules 420a-420n and thereby create parallel threads of processing (i.e., child threads) to handle generation of processed units (or portions of price quote 160). Each of the parallel site processing modules 420a-420n is configured to independently process the assigned discrete processing unit.

Monitoring logic 530 may determine when the processing of each discrete processing unit has been completed. For, example, monitoring logic 530 may receive an indication from each of the parallel site processing modules 420 when the assigned discrete processing unit has been processed. Monitoring logic 530 may notify merger module 430 at the completion. Alternatively, monitoring logic 530 may notify merger module 430 when a batch (e.g., a subgroup of client sites that are associated with a particular business line of the client enterprise) of processed units that is to be concatenated has been completed.

FIG. 6 is an exemplary functional block diagram of one of the plurality of parallel site processing modules 420 according to an exemplary implementation. As shown in FIG. 6, parallel site processing module 420 may include data access logic 610 and processing logic 620.

Each of the parallel site processing modules 420a-420n may execute an atomic process and may retrieve (and process) price quote generation data 132 on a per site, per product, and/or per provider entity basis while applying relevant business logic to generate an output in a predetermined format (e.g., XML). The parallel site processing modules 420a-420n may process price quotes for different sites at a same time.

Data access logic 610 may receive an assigned discrete processing unit. Data access logic 610 may access price quote generation data 132, stored for example in database system 150, based on particular requirements included in the discrete processing unit (i.e., products and or services included in the price quote for the particular client site, products and or provider legal entity included in the discrete processing unit. Data access logic 610 may retrieve the price quote generation data 132 in a nested process based on how the data is architected and stored.

Processing logic 620 may determine price quotes for a particular site based on data included in the discrete processing unit (retrieved from the client request for price quote 402 and assigned to the particular parallel site processing modules 420 in the discrete processing unit by site splitting logic 510) and price quote generation data 132 corresponding to that portion of the client request 402. Processing logic 620 may process each site in sequential form and in an order determined by the hierarchical structure. Processing logic 620 may insert transaction specific information including variables and descriptions into a processed unit (i.e., a portion of price quote 160). Processing logic 620 may also apply rules to determine whether a given line item is to be displayed in the price quote document 160. In some implementations, processing logic 620 may process and populate the price quote document 160 based on site and product options and provide an option for sorting (or exploring) the document in a product view in a node tree structure (e.g., an online document with an additional feature that allows the user to break out particular sub-transactions).

Processing logic 620 may include instructions to insert a hidden tag next to each of the product definitions where a footnote or other global variable is required. The hidden tag may provide a signal to merger module 430 that the footnote is to be inserted at that place in the document.

FIG. 7 is an exemplary functional block diagram of merger module 430 according to an exemplary implementation. As shown in FIG. 7, merger module 430 may include sequence determination logic 710, concatenation logic 720, and global variables application logic 730.

Sequence determination logic 710 may determine a sequence that processed units are to be grouped and/or sorted. Sequence determination logic 710 may receive the sequence that the processed units are to be joined from site splitting logic 510. Site splitting logic 510 may determine (or identify) the sequence during the process of splitting the request for price quote into discrete processing units and send the identified sequence to sequence determination logic 710. Sequence determination logic 710 may sort the processed units (e.g., XML representations of the subs transaction that has been processed in from the parallel site processing modules 420a-420n) based on a sequence provided by site splitting logic 510. Alternatively, sequence determination logic 710 may determine a sequence based on a predetermined indexing system.

Concatenation logic 720 may execute one or more merge processes after parallel site processing modules 420a-420n have completed processing of the discrete processing units to form processed units. For example, a monitoring process may identify when all parallel site processing modules 420a-420n are done processing and trigger a merger of the processed units. Concatenation logic 720 may receive processed units from parallel site processing modules 420a-420n. Concatenation logic 720 may aggregate the processed units. Concatenation logic 720 may aggregate the processed units based on an extensible Stylesheet language transformations (XSLT) to XML transformation.

Global variables application logic 730 may receive the aggregated processed units and apply all the final business logic (read from XSLT) including summary total of provider legal entity (or subdivision), client legal entity (or subdivision), products, etc. Global variables application logic 730 may recognize hidden variables and insert global (general) numbers, footnotes and other global variables. Global variables application logic 730 may also insert plot legends and also any global variables that span across multiple client sites, products, provider legal entity. Global variables application logic 730 may ensure that global uniqueness is met for page numbers, sequencing of section number and other global variables in price quote 160 (e.g., quote PDF). Global variables application logic 730 may put all global identifiers in according to rules for footnote mapping and/or subtotal mapping.

Global variables application logic 730 may apply global promotions and/or discounts. In other instances, the personnel may apply discounts locally. After applying a discount, global variables application logic 730 may apply rounding in instances in which the amount of the price quote is no longer rounded after the discount.

Global variables application logic 730 may identify sub-sequences of the request for price quote based on multiple discrete processing units. Global variables application logic 730 may apply subtotals based on the identified sub-sequence (or subgroup).

Global variables application logic 730 may apply formatting. For example, global variables application logic 730 may format amounts of price quotes. For example, global variables application logic 730 may insert the thousands separator every three digits (as in “1,234,567”). Global variables application logic 730 may also apply formatting to ensure the consistency of any predetermined formatting patterns across the price quote 160 (e.g., particular color pages for particular client entities, etc.).

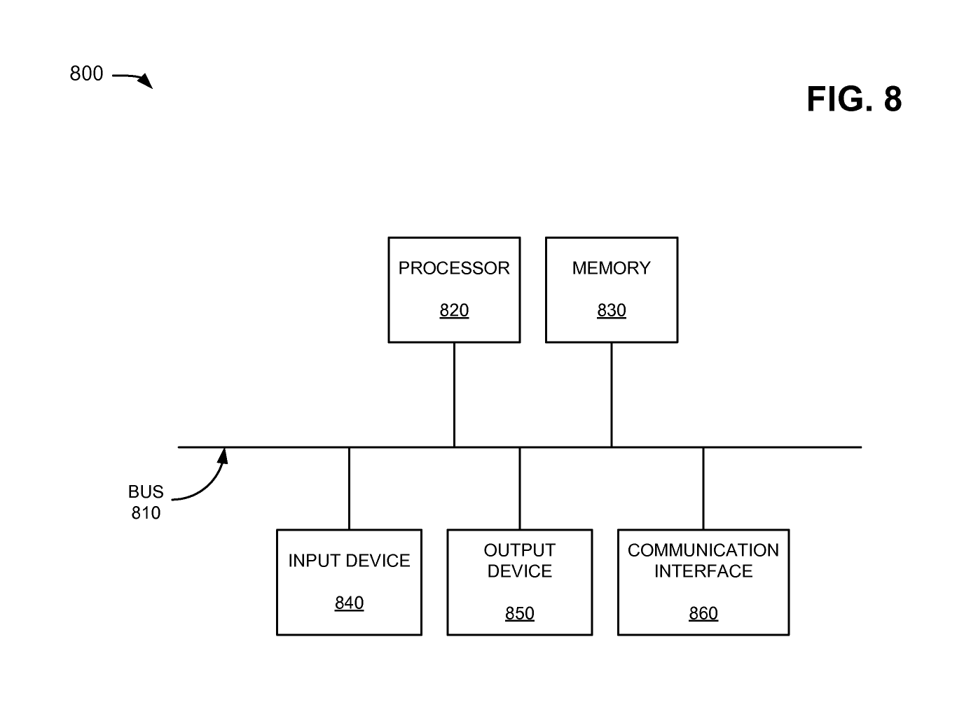

FIG. 8 is a diagram of example components of a device 800. Each of user interface device 102, an enterprise quote generation system 120, a database system 130, and/or output device 150 may include one or more devices 800. As shown in FIG. 8, device 800 may include a bus 810, a processor 820, a memory 830, an input device 840, an output device 850, and a communication interface 860.

Bus 810 may permit communication among the components of device 800. Processor 820 may include one or more processors or microprocessors that interpret and execute instructions. In other implementations, processor 820 may be implemented as or include one or more application specific integrated circuits (ASICs), field programmable gate arrays (FPGAs), or the like.

Memory 830 may include a random access memory (RAM) or another type of dynamic storage device that stores information and instructions for execution by processor 820, a read only memory (ROM) or another type of static storage device that stores static information and instructions for the processor 820, and/or some other type of magnetic or optical recording medium and its corresponding drive for storing information and/or instructions.

Input device 840 may include a device that permits an operator to input information to device 800, such as a keyboard, a keypad, a mouse, a pen, a microphone, one or more biometric mechanisms, and the like. Output device 850 may include a device that outputs information to the operator, such as a display, a speaker, etc.

Communication interface 860 may include a transceiver that enables device 800 to communicate with other devices and/or systems. For example, communication interface 860 may include mechanisms for communicating with other devices, such as other devices of environment 100.

As described herein, device 800 may perform certain operations in response to processor 820 executing software instructions contained in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device via communication interface 860. The software instructions contained in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

Although FIG. 8 shows example components of device 800, in other implementations, device 800 may include fewer components, different components, differently arranged components, or additional components than depicted in FIG. 8. Alternatively, or additionally, one or more components of device 800 may perform one or more other tasks described as being performed by one or more other components of device 800.

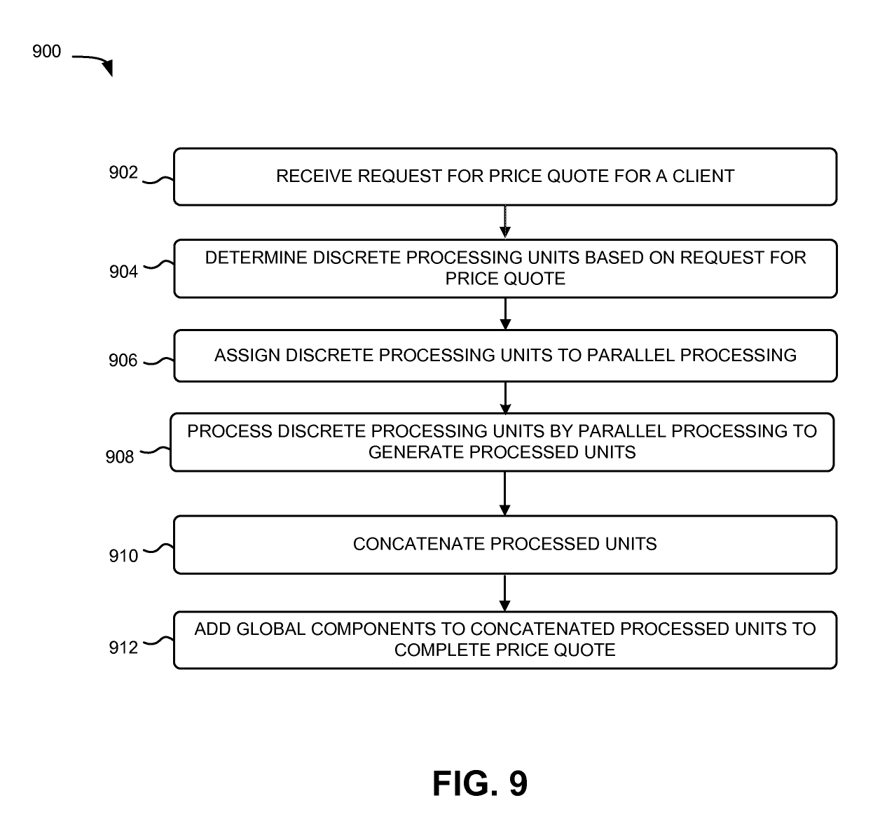

FIG. 9 is a flowchart of an exemplary process 900 for generating large scale electronic documentation for an enterprise-to-enterprise transaction. Process 900 may execute in enterprise quote generation system 120. In another implementation, some or all of process 900 may be performed by another device or group of devices, including or excluding enterprise quote generation system 120. It should be apparent that the process discussed below with respect to FIG. 9 represents a generalized illustration and that blocks/steps may be added or existing blocks/steps may be removed, modified or rearranged without departing from the scope of process 900.

At block 902, enterprise quote generation system 120 may receive a request for price quote associated with a client enterprise. For example, enterprise quote generation system 120 may receive a request for a price quote that includes multiple sites of a client enterprise, multiple products or service, and/or multiple sub-entities of the client enterprise or the provider. Enterprise quote generation system 120 may determine that the quote is larger than a threshold size and requires parallel processing. The threshold size may be determined based on projected run time (data to be processed matched to available computing time/historic projected runtime) to complete the price quote 160 (e.g., based on sequential versus parallel processing).

According to one embodiment, enterprise quote generation system 120 may receive a request for price quote that requires a particular arrangement (or grouping) of sub-transactions within the price quote. For example, the requirement for the particular arrangement may include groupings of particular products based on client enterprise request, product similarity, product package, region, etc., display styles (e.g., a tree structure may highlight dependent costs), charge figure threshold (e.g., charges over a particular number may be required to be broken down into smaller line items), highlighting of savings, etc. The requirement for particular arrangement or grouping of sub-transactions and sub-charges or dependent charges may be input by a user via user interface device 102

At block 904, enterprise quote generation system 120 may determine discrete processing units based on the request for price quote. For example, enterprise quote generation system 120 may identify client site locations and corresponding products from the provider enterprise to be provided at the client locations based on the request for price quote. Enterprise quote generation system 120 may determine discrete processing units based on the identified client locations and corresponding products.

At block 906, enterprise quote generation system 120 may assign the discrete processing units to parallel site processing modules 420a-420n. For example, enterprise quote generation system 120 may assign each of the discrete processing units based on a number of available parallel site processing modules 420a-420n (e.g., each parallel site processing modules 420a-420n may be assigned the same approximate number of discrete processing units). Alternatively, enterprise quote generation system 120 may assign the discrete processing units based on an expected approximately equivalent time of processing (data to be processed matched to available computing time or historic projected runtime) for the discrete processing units by the parallel site processing modules 420a-420n.

According to one embodiment, enterprise quote generation system 120 may assign a first batch of discrete processing units to the parallel site processing modules 420a-420n. Enterprise quote generation system 120 may assign additional discreet processing units based on receipt of a completion indication from each of the parallel site processing modules 420a-420n.

Parallel site processing modules 420a-420n may process the discrete processing units by parallel processing to generate processed units (block 908). For example, parallel site processing modules 420a-420n may access price quote generation data 132, which may be stored in a hierarchical manner in database 130. The price quote generation data 132 may allow the parallel site processing modules 420a-420n to generate price quote for each discrete processing unit. Each of the parallel site processing modules 420a-420n may process the assigned units (of the plurality of discrete processing units) based on the price quote generation data corresponding to the requirements in the particular discrete processing unit to generate a corresponding plurality of processed units.

The price quote generation data 132 may be stored in database 130 in a different levels including a first level (that includes information that enables population of price quote on the basis of a particular site), a second level (that includes information that enables population of the particular site (in price quote 160) on the basis a particular product), a third level (that includes information that enables population of particular features based on the particular product), a fourth level (that includes information that enables population of particular line items based on particular features), and a fifth level (that includes information that enables population of particular charges based on the particular line items).

At block 910, enterprise quote generation system 120 may concatenate the processed units. For example, enterprise quote generation system 120 may poll each parallel site processing module 420 to determine status of each processing thread (i.e., towards completion of processing the discrete processing units) and restart processing thread (i.e., a current point in the process of generating the processed units) in the event of process failures or if enterprise quote generation system 120 determines that an expected output has not been generated. In some instances, the enterprise quote generation system 120 may identify subgroups that have completed processing. Enterprise quote generation system 120 may then merge the processed units.

Enterprise quote generation system 120 may apply global variables to the merged processed units (block 912). For example, enterprise quote generation system 120 may insert footnotes, page numbers and other global variables. Enterprise quote generation system 120 may also append global components such as appendices, directories, etc. In some implementations, enterprise quote generation system 120 may add hyper-links from references to particular appendices in the price quote to the referenced appendix.

Systems and/or methods described herein may generate large scale electronic documentation for an enterprise-to-enterprise transaction. The enterprise-to-enterprise transaction may include multiple sub-transactions that include multiple locations of a client enterprise. The systems may receive a request for a price quote and divide the request into multiple discrete processing units. The systems may allow parallel processing of the multiple discrete processing units. The systems may merge the multiple processed units in one or more predetermined sequences and apply global processing to the multiple processed units and/or subgroups of the multiple processed units based on metadata definitions.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 9, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the embodiments unless explicitly described as such. Also, as used herein, the articles “a”, “an” and “the” are intended to include one or more items. Further, the phrase “based on” is intended to mean “based, at least in part, on” unless explicitly stated otherwise.

What is claimed is:

1. A computer-implemented method comprising:
receiving, from a client enterprise, at a provider computing device, a request for price quote for products provided by a provider enterprise;
determining, by the provider computing device, a plurality of discrete processing units based on the request for price quote;
assigning each of the plurality of discrete processing units to a single one of a plurality of parallel processing devices;
accessing, by each of the plurality of parallel processing devices, price quote generation data stored in a hierarchical manner in a database associated with the provider;
processing, by each of the plurality of parallel processing devices, the plurality of discrete processing units based on the price quote generation data to generate a corresponding plurality of processed units;
merging the processed units to form concatenated processed units; and
adding global components to the concatenated processed units to form the price quote.

2. The computer-implemented method of claim 1, further comprising:
outputting the price quote as one of a PDF, Excel, or a word document.

3. The computer-implemented method of claim 1, wherein the price quote generation data is stored in a hierarchical structure that includes:
a first level, wherein the first level includes information that enables population of a particular location,
a second level, wherein the second level includes information that enables population of a particular product,
a third level, wherein the third level enables population of particular features based on the particular product,
a fourth level, wherein the fourth level enables population of particular line items based on the particular product, and
a fifth level, wherein the fifth level includes information that enables population of charges based on the particular line items.

4. The computer-implemented method of claim 1, wherein merging the processed units to form the concatenated processed units further comprises:
outputting the concatenated processed units as an Extensible markup language document.

5. The computer-implemented method of claim 1, wherein determining the discrete processing units further comprises:
determining the discrete processing units based on one or more of a provider legal entity, a product line, a geographical location, or a client division.

6. The computer-implemented method of claim 1, wherein assigning the discrete processing units further comprises:
determining a number of available parallel processing devices; and
assigning the discrete processing units among the plurality of parallel processing devices based on the number of available parallel processing devices.

7. The computer-implemented method of claim 1, wherein adding the global components to the concatenated processed units further comprises:
applying one or more of footnotes, appendices, or global numbers.

8. The computer-implemented method of claim 7, wherein applying the footnotes further comprises:
applying the footnotes based on footnote mapping.

9. The computer-implemented method of claim 1, wherein merging the processed units to form the concatenated processed units further comprises:
identifying sub-sequences of the request for price quote based on multiple discrete processing units; and
applying a subtotal to the identified sub-sequence.

10. The computer-implemented method of claim 1, wherein processing the discrete processing units further comprises:
applying a hidden indicator to include a footnote in the processed units.

11. The computer-implemented method of claim 1, wherein determining the discrete processing units further comprises:
identifying client locations and corresponding products from the provider enterprise to be provided at the client locations based on the request for price quote; and
determining the discrete processing units based on the client locations.

12. The computer-implemented method of claim 1, wherein processing the discrete processing units by the parallel processors further comprises:
accessing price quote generation data by each of the parallel processors concurrently, wherein the price quote generation data allows to generate a portion of the price quote for each of the discrete processing unit,

13. A device, comprising:
a memory to store a plurality of instructions; and
a processor configured to execute the instructions in the memory to:
receive, from a client enterprise, a request for price quote for products provided by a provider enterprise;
determine a plurality of discrete processing units based on the request for price quote;
assign each of the plurality of discrete processing units to a single one of a plurality of parallel processing devices;
access, by each of the plurality of parallel processing devices, price quote generation data stored in a hierarchical manner in a database associated with the provider;
process, by each of the plurality of parallel processing devices, the plurality of discrete processing units based on the price quote generation data to generate a corresponding plurality of processed units;
merge the processed units to form concatenated processed units; and
add global components to the concatenated processed units to form the price quote.

14. The device of claim 13, where the processor is further to:
output the price quote as one of a PDF, Excel, or a word document.

15. The device of claim 13, wherein the each of the plurality of parallel processing devices is operable to provide reporting information to the device based on progress of the processing of the assigned discrete processing unit.

16. The device of claim 13, wherein, when merging the processed units to form the concatenated processed units, the processor is further to:
output the concatenated processed units as an Extensible markup language document.

17. The device of claim 14, wherein, when determining the discrete processing units, the processor is further to:
determine the discrete processing units based on one or more of a provider legal entity, a product line, a geographical location, or a client division.

18. The device of claim 11, wherein, when assigning the discrete processing units, the processor is further to:
assign a first batch of discrete processing units to the parallel processors; and
assign additional discreet processing units based on receipt of a completion indication from each of the parallel processors.

19. A computer-readable medium including instructions to be executed by a processor, the instructions including one or more instructions, which when executed by the processor, cause the processor to:
receive, from a client enterprise, a request for price quote for products provided by a provider enterprise;
determine a plurality of discrete processing units based on the request for price quote;
assign each of the plurality of discrete processing units to a single one of a plurality of parallel processing devices;
access, by each of the plurality of parallel processing devices, price quote generation data stored in a hierarchical manner in a database associated with the provider
process, by each of the plurality of parallel processing devices, the plurality of discrete processing units based on the price quote generation data to generate a corresponding plurality of processed units;
merge the processed units to form concatenated processed units; and
add global components to the concatenated processed units to form the price quote.

20. The computer-readable medium of claim 19, wherein the one or more instructions further includes instructions to:
determine the discrete processing units based on one or more of a provider legal entity, a product line, a geographical location, or a client division.
